(19) United States
(12) Patent Application Publication
(10) Pub. No.: US 2007/0045349 A1
(43) Pub. Date: Mar. 1, 2007

(54) Liquid dispensing pump with shifting liquid piston

(75) Inventors: Donald D. Foster, St. Charles, MO (US); Philip L. Nelson, Wildwood, MO (US)

Correspondence Address: THOMPSON COBURN, LLP, ONE US BANK PLAZA, SUITE 3500, ST LOUIS, MO, 63101, US

(73) Assignee: Continental AFA Dispensing Company

(21) Appl. No.: 11/211,395

(22) Filed: Aug. 25, 2005

(51) Int. Cl. G01F 11/00

(52) U.S. Cl. 222/321.9

(57) ABSTRACT

A manually operated pump dispenser is attached to the top of a bottle of liquid and pumps and dispenses liquid from the bottle. The dispenser includes a pump housing containing a liquid pump chamber, and a pump plunger that is manually reciprocated in the pump chamber. A liquid piston is mounted on the pump plunger and is reciprocated in the pump chamber by the pump plunger. The liquid piston is mounted on the pump plunger for limited axial movement of the piston on the plunger. The movement of the piston on the plunger opens and closes a liquid flow path between the interior of the liquid pump chamber and a liquid discharge passage passing through the pump plunger.

### BACKGROUND OF THE INVENTION

(1) Field of the Invention.

The present invention pertains to a manually operated liquid dispenser. Specifically, the invention pertains to a manually operated pump dispenser that is attached to the top of a bottle of liquid and that pumps and dispenses liquid from the bottle. The dispenser includes a pump housing containing a liquid pump chamber, and a pump plunger that is manually reciprocated in the pump chamber. A liquid piston is mounted on the pump plunger and is reciprocated in the pump chamber by the pump plunger. The liquid piston is mounted on the pump plunger for limited axial movement of the piston on the plunger. The movement of the piston on the plunger opens and closes a liquid flow path between the interior of the liquid pump chamber and a liquid discharge passage passing through the pump plunger.

(2) Description of the Related Art

Manually operated vertically reciprocated pumps, often referred to as lotion pumps, typically include a pump housing that is attached to the neck of a liquid container and a manually operated pump plunger that extends vertically downwardly into the pump housing.

The pump housing includes a pump chamber that is located in the interior of the liquid container. A dip tube extends downwardly from the pump chamber into the liquid. A one-way valve is positioned between the pump chamber and the dip tube and controls the flow of liquid into the pump chamber from the dip tube, but prevents the reverse flow of liquid. A spring is typically positioned inside the pump chamber.

The pump plunger is mounted in the pump chamber for vertical reciprocating movement. The pump plunger is tubular and has a liquid discharge passage extending through the plunger from a bottom end to a top end of the plunger. A piston is provided at the plunger bottom and is positioned inside the pump chamber. A dispenser head having a directional spout is provided on the top of the pump plunger. The spring in the pump chamber engages against the bottom end of the pump plunger and biases the plunger and piston upwardly. A second one-way valve is typically located in the pump plunger discharge passage adjacent the pump piston. The second valve permits the flow of liquid from the pump chamber upwardly through the pump plunger to the dispenser head at the top of the pump plunger, but prevents the reverse flow of liquid.

By manually pressing the pump plunger downwardly into the pump housing, the pump piston moves downwardly through the pump chamber and compresses the fluid in the pump chamber. This causes the first one-way valve to close and causes the second one-way valve to open. The fluid in the pump chamber moves upwardly past the second one-way valve and through the plunger and is dispensed from the dispenser head at the top of the plunger.

Releasing the plunger allows the spring in the pump chamber to push the plunger upwardly relative to the pump housing. This moves the piston upwardly through the pump chamber and creates a vacuum in the pump chamber. The vacuum causes the second one-way valve to close and causes the first one-way valve to open, drawing liquid from the container into the pump chamber. On subsequent manual downward and upward manipulation of the pump plunger relative to the pump housing, the liquid drawn into the pump chamber is dispensed from the dispenser head.

A substantial number of manually operated vertically reciprocated pumps are manufactured to meet the needs of consumers. Reducing the manufacturing costs of a manually operated liquid dispenser of this type by only a small degree, for example by one penny or a fraction of a penny, significantly reduces the manufacturing costs of the manually operated liquid dispensers due to the significant number of the dispensers manufactured. Thus, a change in the design of a manually operated liquid dispenser that results in even a small reduction in the manufacturing costs could result in a significant benefit to the manufacturing of manually operated liquid dispensers.

### SUMMARY OF THE INVENTION

The manually operated liquid dispenser of the present invention has a novel and simplified construction with a reduced number of component parts from that of prior art dispensers. The novel construction of the liquid dispenser eliminates the valve that controls the flow of liquid from the liquid pump chamber to the discharge passage of the dispenser, and thereby eliminates the cost of the valve and reduces the manufacturing costs of the dispenser. In addition, the manually operated liquid dispenser of the invention has a more simplified construction than that of other prior art liquid dispensers. The more simplified construction of the dispenser also results in a reduction in manufacturing costs.

The dispenser of the invention comprises many of the same component parts found in the typical vertically reciprocated liquid dispenser. The dispenser is basically comprised of a pump housing and a pump plunger that is mounted in the pump housing for manual, vertical reciprocating movement of the plunger in the pump housing.

The pump housing is basically comprised of a cylindrical pump chamber and a cylindrical dip tube connector at the bottom of the pump chamber. The dip tube extends downwardly from the dip tube connector. With the pump housing connected to the neck of a bottle container, the pump chamber and the dip tube are inserted through the container neck and into the container interior. A liquid inlet valve is positioned in the pump chamber above the dip tube. The liquid inlet valve controls the flow of liquid into the pump chamber through the dip tube, and prevents the reverse flow. A metal coil spring is positioned in the pump chamber above the inlet valve.

The pump plunger is tubular and has a liquid discharge passage extending through the length of the pump plunger. The pump plunger is inserted into the pump housing with the bottom end of the pump plunger being positioned in the pump chamber in engagement with the coil spring. A dispenser head is provided at the top of the pump plunger. The dispenser head includes a spout that directs the liquid discharged from the dispenser. A pump piston is provided on the bottom end of the pump plunger in the pump chamber.

The construction of the liquid dispenser of the invention differs from that of prior art dispensers in that it does not include a valve that controls the flow of liquid from the pump chamber through the liquid discharge passage of the pump plunger. Instead, the liquid piston is provided with a cylindrical base that is mounted on the pump plunger for limited axial movement. The pump plunger is provided with a first annular projection below the liquid piston and a second annular projection above the liquid piston. The axial spacing between the two plunger projections limits the axial movement of the piston on the plunger. A plurality of liquid outlet holes are provided through the plunger between the first and second projections. The liquid outlet holes communicate the interior of the pump chamber with the liquid discharge passage extending through the plunger. The liquid piston is mounted on the plunger for movement between a first position of the piston relative to the plunger where the piston engages the first projection of the plunger and seals closed the liquid outlet holes, and a second position of the piston on the plunger where the piston engages the second projection of the plunger and opens a flow path through the liquid outlet holes.

In operation of the liquid dispenser, when the coil spring biases the plunger upwardly in the pump chamber the liquid piston moves on the plunger and seals against the lower, first projection. This closes communication between the pump chamber and the liquid discharge passage of the plunger and creates a vacuum in the pump chamber. The vacuum draws liquid up through the dip tube and into the pump chamber.

On downward movement of the pump plunger through the pump chamber, the piston moves axially on the plunger to engage with the second projection on the plunger. This opens the liquid outlet holes of the plunger and creates a flow path from the pump chamber through the liquid outlet holes into the discharge passage of the plunger. On continued downward movement of the plunger, the plunger pushes the piston downwardly through the pump chamber. The piston forces the liquid from the pump chamber, through the liquid outlet holes and through the pump plunger discharge passage and the liquid is discharged from the dispenser head.

The novel construction of the liquid dispenser of the invention provides the functioning of a liquid outlet valve in the novel construction of the liquid piston and pump plunger. This illuminates a valve from the construction of the liquid dispenser, and thereby reduces manufacturing costs of the dispenser.

### BRIEF DESCRIPTION OF THE DRAWING FIGURES

Further features of the invention are set forth in the following detailed description of the preferred embodiment of the invention and in the drawing figures wherein:

FIG. 1 is a side sectioned view of the manually operated, vertically reciprocated liquid dispenser of the invention in the extended or charge position of the pump plunger; and,

FIG. 2 is a side sectioned view of the dispenser in the retracted or discharge position of the pump plunger.

### DETAILED DESCRIPTION OF THE PREFERRED EMBODIMENT

The liquid dispenser of the present invention is similar to the types of dispensers known in the prior art as lotion dispensers. These types of dispensers are typically operated by connecting the dispenser to the neck of a bottle container containing a liquid, and by orienting the dispenser and the container vertically upright. In the description of the liquid dispenser of the invention to follow, the terms “top” and “bottom”, “upper” and “lower”, or similar related terms will be used to describe the component parts of the dispenser and their relative positions. These terms are only used because the dispenser is typically oriented vertically upright when using the dispenser. The terms should not be interpreted as limiting. The materials employed in constructing the component parts of the dispenser are the same as those typically used in the industry, usually plastics except for a metal coil spring employed in the pump housing.

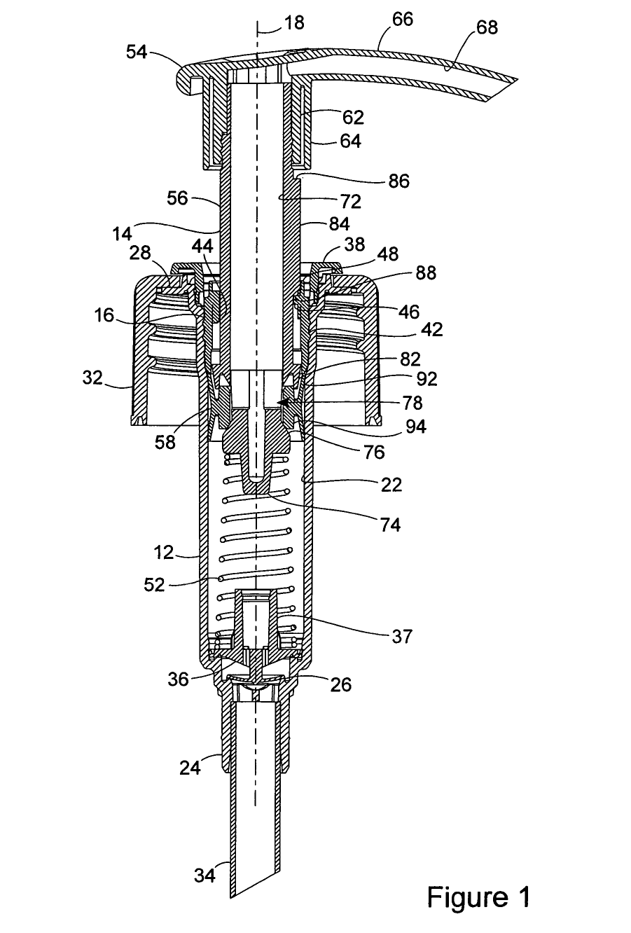

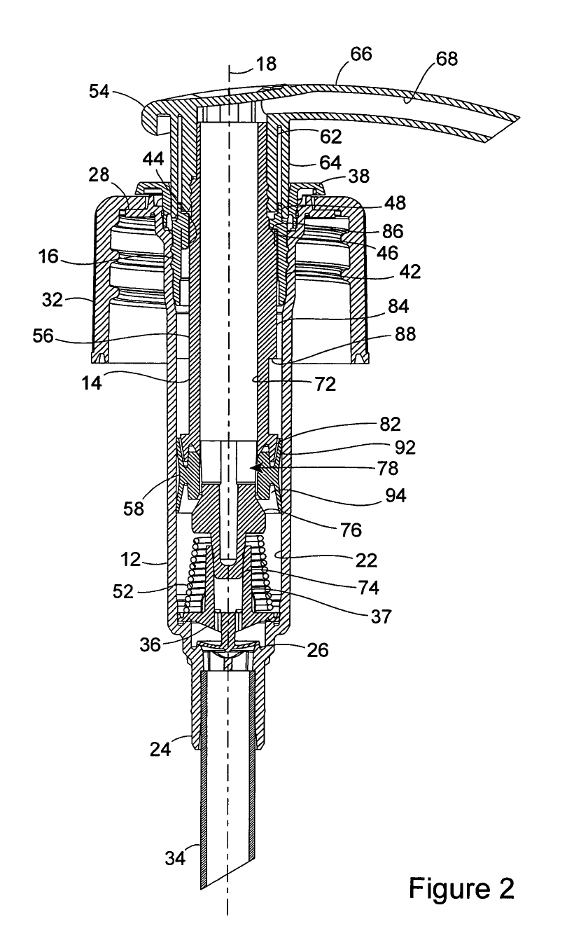

The liquid dispenser shown in FIGS. 1 and 2 is basically comprised of a pump housing 12, a pump plunger 14, and a snap ring 16 that connects the pump housing and the pump plunger together. The pump housing 12 and plunger 14 have a common center axis 18. The center axis 18 defines mutually perpendicular axial and radial directions relative to the dispenser.

The pump housing 12 is basically comprised of two cylindrical sections. The cylindrical sections include a cylindrical dip tube connector 22 provided at the bottom of the pump housing, and a cylindrical liquid pump chamber 24. The pump chamber 24 is positioned just above the dip tube connector 22. A valve seat surface 26 is positioned at the bottom of the pump chamber 24. The interior volume of the pump chamber 24 communicates with the interior of the dip tube connector 22 through the valve seat 26. The pump chamber 24 is open at its top end. An annual flange 28 projects radially outwardly from the top end of the pump chamber 22.

A cylindrical connector cap 32 is mounted on the annular flange 28 of the pump housing 12. As seen in FIGS. 1 and 2, the cap 32 extends downwardly over the annular flange 28 and a portion of the pump chamber 22. An interior surface of the cap 32 is provided with a mechanical connector, for example an internal screw thread type connector. The particular connector employed on the cap 32 will be complementary to a connector on a bottle container with which the liquid dispenser is used. The cap 32 is mounted for rotation on the pump housing annular flange 28 to facilitate screw threading the cap on a screw threaded neck of a bottle container. In the alternative, where the cap 32 has a bayonet type connector, the cap could be formed integrally with the pump housing 12.

A dip tube 34 is attached to the dip tube connector 24 at the bottom of the pump housing 12. The dip tube 34 extends downwardly from the pump housing 12 into the liquid of the container to which the pump housing 12 is attached.

A liquid inlet control valve 36 is positioned inside the pump chamber 32 at the bottom of the pump chamber. The liquid inlet control valve 36 is a flexible, resilient disc that seats against the valve seat surface 26 at the bottom of the liquid pump chamber 22. A cylindrical base 37 with a radially projecting flange holds the valve 36 in place. The liquid inlet control valve 36 is responsive to a vacuum pressure created in the interior volume of the liquid pump chamber 22. The valve 36 controls a flow of liquid from the bottle container through the dip tube 34 and into the liquid pump chamber 22, and prevents the reverse flow of liquid.

The snap ring 16 is assembled to the top of the pump housing 12. The snap ring 16 has an annular top cover 38 and a cylindrical wall 42 that fits snug inside the cylindrical pump chamber 22. The snap ring top cover 38 holds the connector cap 32 on the annular flange 28 of the pump housing 12. The snap ring cylindrical wall 42 holds the snap ring securely to the pump housing 12. In addition, the snap ring cylindrical wall 42 has an annular seal 44 in its interior and a locking tab 46 in its interior. A resilient seal collar 48 projects upwardly a short distance above the inner annular seal 44 and the locking tab 46.

A metal coil spring 52 is assembled in the pump housing 12. The spring 52 is positioned at the bottom of the pump chamber 22 and engages on top of the liquid inlet control valve 36. The spring 52 extends upwardly through the interior of the pump chamber 22 to an upper portion of the pump chamber.

The pump plunger 14 has a tubular length that extends downwardly through the snap ring 16 and into the pump housing 12. The plunger 14 is basically comprised of an upper dispenser head 54, a piston rod 56, and a liquid pump piston 58 mounted on the piston rod.

The dispenser head 54 has an inner cylindrical wall 62 that extends downwardly from the head and a concentric, outer cylindrical wall 64. The inner cylindrical wall 62 couples the dispenser head 54 to the top of the pump plunger piston rod 56. The outer cylindrical wall 64 is spaced radially outwardly from the inner cylindrical wall 62. Both of the cylindrical walls 62, 64 are dimensioned to receive the snap ring seal collar 48 between the bottom ends of the walls to form a sealing connection between the dispenser head 54 and the seal collar 48. A discharge spout 66 projects radially outwardly from the two concentric cylindrical walls 62, 64. An interior bore 68 of the spout 66 communicates with the interior of the dispenser head inner wall 62 and forms a part of a liquid discharge passage extending through the dispenser head.

The pump plunger piston rod 56 has an interior bore 72 that also forms a portion of the liquid discharge passage. From the connection of the top end of the piston rod 56 to the dispenser head 54, the piston rod extends downwardly to a bottom end 74 of the rod. The rod bottom end 74 is formed as a plug that fits into the cylindrical base 37 of the liquid inlet control valve 36 to seal closed the liquid inlet. A first annular projection 76 extends around the piston rod just above the bottom end plug 74 of the rod. The exterior surface of the first projection 76 is formed as a sealing stopper, as will be explained. A plurality of liquid outlet holes 78 extend radially through the piston rod 56 just above the first projection 76. The outlet holes 78 communicate the interior of the pump chamber 22 with the interior bore 72 of the plunger piston rod 56. A second annular projection 82 projects radially outwardly from the piston rod 56 just above the liquid outlet holes 78. The second annular projection 82 is spaced axially above the first annular projection 76 to accommodate the liquid pump piston 58 between the two projections, as will be explained. The second annular projection 82 is formed as an annular seal that engages with the liquid pump piston 58. A locking rib 84 projects radially outwardly from the pump plunger piston rod 56. The rib 84 extends axially along the exterior surface of the rod 56 and has opposite top 86 and bottom 88 surfaces. The pump plunger 14 can be rotated in the pump housing 12 to engage the rib bottom surface 88 against the snap ring locking tab 46 to lock the pump plunger in its extended, charge position shown in FIG. 1. The pump plunger 14 can be rotated to disengage the rib bottom surface 88 from the locking tab 46, allowing the plunger 14 to move downwardly into the pump housing 12 to its retracted, discharge position show in FIG. 2. In the retracted, discharge position of the pump plunger 14, the plunger can be rotated in the pump housing 12 to engage the rib top surface 86 beneath the locking tab 46 to lock the plunger in the retracted, discharge position in FIG. 2.

The liquid pump piston 58 is mounted on the plunger piston rod 56 between the first annular projection 76 and the second annular projection 82. The pump piston 58 is comprised of a resilient outer cylindrical wall 92 that engages in a sealing, sliding engagement with the interior surface of the pump chamber 22. The cylindrical wall is connected to a center cylindrical base 94 of the pump piston. The piston base 94 has an axial length that is slightly shorter than the axial spacing between the first annular projection 76 and the second annular projection 82 of the piston rod 56. This allows the liquid pump piston 58 to move axially relative to the plunger piston rod 56. The pump piston 58 can move axially between a first position of the piston relative to the plunger 14 where the piston cylindrical base 94 engages in a sealing engagement around the first annular projection 76 of the piston rod, and a second position of the pump piston relative to the piston rod where the piston cylindrical base 94 engages in a sealing engagement with the second annular projection 82 of the piston rod. As seen in FIG. 1, when the liquid pump piston 58 is in its first position relative to the pump plunger 14, the engagement of the piston cylindrical base 94 around the rod first projection 76 seals the interior of the pump chamber 22 from the interior bore 72 of the pump plunger 14. This also closes the flow path of liquid from the interior of the pump chamber 22 through the liquid outlet holes 78 of the pump plunger to the plunger interior bore 72. When the pump piston 58 is move to it second position relative to the pump plunger 14, the piston cylindrical base 94 engages against the second annular projection 82 of the plunger and is spaced axially from the first annular projection 76. This opens a flow path from the pump chamber 22 between the liquid piston 58 and the pump plunger 14 and through the liquid outlet holes 78 to the pump plunger interior bore 72. The engagement of the piston cylindrical base 94 with the second annular projection 82 also seals the interior of the pump chamber 22 from the exterior environment of the pump housing 12, thereby preventing leakage of liquid from the pump chamber to the housing exterior.

In operation of the liquid dispenser, in the extended, charge position of the pump plunger 14 relative to the pump housing 12 shown in FIG. 1, the liquid piston base 94 engages and seals around the first annular projection 76 on the plunger piston rod 56. This seals the interior of the pump chamber 22 from the interior bore 72 of the pump plunger 14. Leakage of liquid from the pump chamber 22 is prevented by this sealing engagement.

When the pump plunger 14 is pushed manually downwardly into the pump housing 12 from the position shown in FIG. 1, the engagement of the liquid piston outer wall 92 with the interior of the pump chamber 22 causes the liquid piston to remain stationary for a short period of time as the pump plunger 14 is moved downwardly through the pump housing 12. This causes the pump piston 58 to move axially relative to the pump plunger 14, with the piston base 94 disengaging from the first annular projection 76 and moving upwardly into engagement with the second annular projection 82. This opens a flow path between the piston base 94 and the first annular projection 76 of the pump plunger 14. As the pump plunger 14 is continued to move downwardly through the pump housing 12, the plunger second annular projection 82 engages against the piston base 94 and pushes the piston downwardly through the pump chamber 22. The movement of the piston through the pump chamber 22 compresses the liquid in the pump chamber and forces the liquid to flow between the piston base 94 and the first annular projection 76, and through the liquid outlet holes 78 and into the pump chamber interior bore 72. The liquid moves upwardly through the interior bore 72 and through the spout bore 68 and is discharged from the liquid dispenser. On continued movement of the pump plunger downwardly, the plunger bottom end plug 78 engages in the base of the liquid inlet control valve 36 and seals the pump chamber 22 from the dip tube 34. The engagement of the liquid piston base 94 with the second annular projection 82 also seals the interior volume of the pump chamber 22 from the exterior environment of the dispenser.

On release of the downward pressure exerted on the pump plunger 14, the coil spring 52 pushes the plunger upwardly. This movement of the plunger 14 again causes the liquid pump piston 58 to move axially relative to the plunger 14. The piston 58 moves downwardly relative to the plunger 14 and the piston base 94 disengages from the second annular projection 82 of the plunger rod and again engages with the first annular projection 76. The sealing engagement of the piston base 94 with the first annular projections 76 of the plunger piston rod 56 creates a vacuum in the pump chamber 22. The vacuum causes the liquid inlet control valve 36 to unseat from the valve seat 26 at the bottom of the pump chamber 22, and liquid is drawn through the dip tube 34 into the pump chamber 22. Continued reciprocating movement of the pump plunger 14 in the pump housing 12 continues to pump liquid into the pump chamber 22 and out through the discharge passage defined by the plunger interior bore 72 and the spout bore 68.

The elimination of an outlet valve by providing a liquid pump piston 58 that is capable of performing the functions of the liquid outlet valve by moving axially on the pump plunger 14 results in a reduction of manufacturing costs of the liquid dispenser. Providing the liquid pump piston 58 that is capable of performing the functions of both a piston and a liquid outlet valve also simplifies the construction of the liquid dispenser by combining different component parts of prior art dispensers into one piece. This simplified construction also reduces the manufacturing costs of the dispenser.

Although the manually operated liquid dispenser of the invention has been described above by reference to a single embodiment, it should be understood that modifications and variations could be made to the dispenser without departing from the intended scope of the invention defined by the following claims.

1) A liquid dispenser comprising:
a pump housing having a liquid pump chamber;
a pump plunger in the pump housing, the pump plunger having a center axis that defines mutually perpendicular axial and radial directions and the pump plunger having an interior discharge passage that extends axially through the pump plunger;
a liquid piston on the pump plunger and positioned in the liquid pump chamber defining an interior volume of the liquid pump chamber, the liquid piston being moveable between charge and discharge positions in the liquid pump chamber where the liquid piston respectively increases and decreases the interior volume of the liquid pump chamber;
and the liquid piston being moveable with respect to the pump plunger between open and closed positions of the liquid piston relative to the pump plunger where in the open position of the liquid piston the liquid pump chamber communicates with the pump plunger discharge passage to discharge liquid from the pump chamber interior volume through the discharge passage, and in the closed position of the liquid piston the liquid pump chamber is sealed closed from the pump plunger discharge passage.

2) The dispenser of claim 1, further comprising:
the liquid piston being mounted on the pump plunger for limited axial movement of the liquid piston between the open position and the closed position of the liquid piston relative to the pump plunger.

3) The dispenser of claim 1, further comprising:
a hole passing through the liquid piston;
the pump plunger extending through the liquid piston hole, the liquid piston hole defining a liquid flow path between the plunger and the liquid piston that communicates the liquid pump chamber interior volume with the pump plunger discharge passage when the liquid piston is moved to the open position relative to the pump plunger.

4) The dispenser of claim 1, further comprising:
a hole passing through the liquid piston;
the pump plunger extending through the liquid piston hole thereby mounting the liquid piston on the pump plunger for movement of the liquid piston between the open and closed positions of the liquid piston relative to the pump plunger;
a first projection on the pump plunger on one side of the liquid piston;
a second projection on the pump plunger spaced axially from the first projection on an opposite side of the liquid piston from the first projection, the first projection and second projection limiting the movement of the liquid piston relative to the pump plunger in the axial spacing between the first projection and second projection.

5) The dispenser of claim 4, further comprising:
the liquid piston hole defining a liquid flow path between the plunger and the liquid piston that communicates the pump chamber interior volume with the pump plunger discharge passage when the liquid piston is moved to the open position relative to the pump plunger; and,
the first projection being positioned on the plunger to engage with the liquid piston and close the liquid piston hole and the liquid flow path when the liquid piston is moved to the closed position relative to the pump plunger.

6) The dispenser of claim 5, further comprising:
the first projection being an annular stopper that extends around the pump plunger and is positioned to engage in the liquid piston hole when the liquid piston is in the closed position relative to the plunger to close the liquid piston hole.

7) The dispenser of claim 5 further comprising:
the second projection being positioned on the pump plunger to engage with the liquid piston when the liquid piston is moved to the open position relative to the pump plunger to stop movement of the liquid piston and keep open the liquid flow path between the pump plunger and the liquid piston.

8) The dispenser of claim 5, further comprising:
the second projection being an annular seal that extends around the pump plunger in a position to engage the liquid piston when the liquid piston is moved to the open position and to keep open the liquid flow path between the pump plunger and the liquid piston.

9) The dispenser of claim 3, further comprising:
the hole being the only hole through the liquid piston.

10) The dispenser of claim 3, further comprising:
the liquid piston being mounted on the pump plunger for limited axial movement of the liquid piston relative to the pump plunger.

11) The dispenser of claim 10, further comprising:
a liquid pump chamber outlet hole positioned in the pump plunger to direct a flow of liquid out of the liquid pump chamber and through the outlet hole to the pump plunger discharge passage, the outlet hole being separate from the liquid piston.

12) A liquid dispenser comprising:
a pump housing having a liquid pump chamber;
a pump plunger mounted on the pump housing for reciprocating movement between an extended and a retracted position of the pump plunger relative to the pump housing, the pump plunger having a center axis that defines mutually perpendicular axial and radial directions and the pump plunger having an interior discharge passage that extends axially through the pump plunger;
a liquid piston on the pump plunger and positioned in the liquid pump chamber defining an interior volume of the liquid pump chamber, the liquid piston being moveable between charge and discharge positions in the liquid pump chamber in response to the pump plunger moving between the respective extended and retracted positions, where the liquid piston increases and decreases the interior volume of the liquid pump chamber when moved to the respective charge and discharge positions;
a hole in the liquid piston, the hole defining a liquid flow path from the interior volume of the liquid pump chamber through the hole to the pump plunger discharge passage; and,
a projection positioned on the plunger to open the liquid piston hole in response to the pump plunger being moved to the retracted position and to close the hole in response to the pump plunger being moved to the extended position.

13) The dispenser of claim 12, further comprising:
the liquid piston being mounted on the pump plunger for axial movement of the liquid piston between open and closed positions of the liquid piston relative to the pump plunger in response to the pump plunger being moved between the respective retracted and extended positions, the projection on the pump plunger being displaced from the liquid piston hole in the open position of the liquid piston, and the projection on the pump plunger closing the liquid piston hole in the closed position of the liquid piston.

14) The dispenser of claim 12, further comprising:
the pump plunger extending through the liquid piston hole whereby the liquid piston is mounted on the pump plunger.

15) The dispenser of claim 14, further comprising:
the projection on the pump plunger being an annular projection that extends around the pump plunger and is positioned on the plunger to seat over the liquid piston hole to close the hole.

16) The dispenser of claim 15, further comprising:
the annular projection unseating from the liquid piston hole in response to the pump plunger being moved to the retracted position and thereby establishing a liquid flow path from the liquid pump chamber interior volume and through a radial spacing between the pump plunger and the liquid piston to the pump plunger discharge passage.

17) The dispenser of claim 15, further comprising:
the annular projection being on one side of the liquid piston and a second projection on an opposite side of the liquid piston from the annular projection, the annular projection and the second projection enabling limited axial movement of the liquid piston relative to the pump plunger between the annular projection and the second projection.

18) The dispenser of claim 17, further comprising:
the second projection being an annular seal that extends around the pump plunger in a position to engage with the liquid piston in the open position of the liquid piston and establish a liquid flow path between the pump plunger and the liquid piston communicating the liquid pump chamber interior volume with the pump plunger discharge passage.

19) The dispenser of claim 12, further comprising:
the liquid piston being mounted on the pump plunger for limited axial movement of the liquid piston relative to the pump plunger.

20) The dispenser of claim 14, further comprising:
the liquid piston hole being the only hole through the liquid piston.
